(19) United States
(12) Patent Application Publication
(10) Pub. No.: US 2006/0277750 A1
(43) Pub. Date: Dec. 14, 2006

(54) Line and method for assembling accumulator batteries

(75) Inventor: Stefano Pol, Verona (IT)

Correspondence Address: BROWDY AND NEIMARK, P.L.L.C.;624 NINTH STREET, NW, SUITE 300, WASHINGTON, DC, 20001-5303, US

(73) Assignee: SOVEMA S.r.l, Via Spagna (IT)

(21) Appl. No.: 11/236,592

(22) Filed: Sep. 28, 2005

(30) Foreign Application Priority Data
Jun. 14, 2005 (IT) IT-VR2005A000078

(51) Int. Cl. H01M 10/04

(52) U.S. Cl. 29/623.1; 29/730

(57) ABSTRACT

A line for assembling accumulator batteries comprises movement means forming a feed path for the batteries, and a plurality of operating stations mounted along the feed path, each designed to perform at least one operation on the batteries. The movement means are prepared in such a way that they keep the batteries grouped in groups each comprising a plurality of batteries drawn near to one another along a respective main side, and can be activated to move each group in sequence through the stations. There is also an assembly method comprising a first operating step in which a plurality of batteries to be assembled are picked up, being placed side by side along the main side to form a group of batteries to be assembled. Moreover, at least some of the successive assembly operating steps are performed simultaneously on all of the batteries in the group.

### BACKGROUND OF THE INVENTION

The present invention relates to a line and method for assembling accumulator batteries.

At present, lines for assembling batteries have feed means which feed the batteries with a stepping motion from an infeed section (in which they are without a lid 18 and have no connections between the internal elements) to an outfeed section (in which the batteries are substantially complete), through a plurality of operating stations. In particular, the batteries are fed one at a time in a direction parallel with their main direction of extension (seen from above).

The operating stations are normally side by side, along the feed path for the batteries and have a front active zone at the batteries, and a rear control zone (comprising the electrical panels, etc.) located behind the front zone.

Therefore, the assembly method currently used involves feeding each battery 2 with a jog motion through each operating station 9. In each station one or more steps are performed, for example connection of the internal elements, application of lids, checking resistance to short-circuits, etc. Of all of the operating steps, the step of joining the lid 18 to the body containing the battery 2 is the one which usually requires the most time for its completion.

However, this known technology has several disadvantages.

In particular, the main disadvantages of the currently known assembly lines are on one hand their limited production capacity, determined by the speed of the lid joining station, and on the other hand their relatively large overall dimensions.

In addition, in the known lines, it is relatively difficult to gain access to the active zone of the line.

As regards the assembly method currently used, its main limit is the poor production capacity and therefore coincides with that of the lines which implement it.

### SUMMARY OF THE INVENTION

In this situation, the technical need which forms the basis of the present invention is to set up a line and method for assembling accumulator batteries which overcome the above-mentioned disadvantages.

In particular, the technical need of the present invention is to set up a line and method for assembling accumulator batteries which can guarantee a production capacity higher than the known lines and methods.

Another technical need of the present invention is to provide a line for assembling accumulator batteries that has smaller overall dimensions than the known lines.

Yet another technical need of the present invention is to provide a line for assembling accumulator batteries which allows easy access to the feed path for the batteries along the entire line.

The technical need specified and the aims indicated are substantially achieved by a line and method for assembling accumulator batteries as described in the claims herein.

### BRIEF DESCRIPTION OF THE DRAWINGS

Further features and advantages of the present invention are more apparent from the detailed description which follows of several preferred, non-limiting embodiments of a line and method for assembling accumulator batteries, with reference to the accompanying drawings, in which:

FIG. 1 is an axonometric top view of an assembly line in accordance with the present invention;

FIG. 2 is a top view of the line illustrated in FIG. 1;

FIG. 3 is a front view of the line illustrated in FIG. 1;

FIG. 4 is a side view of the line illustrated in FIG. 1;

FIG. 5 is an enlarged detail of the line illustrated in FIG. 3; and

FIG. 6 is another enlarged detail of the line illustrated in FIG. 3.

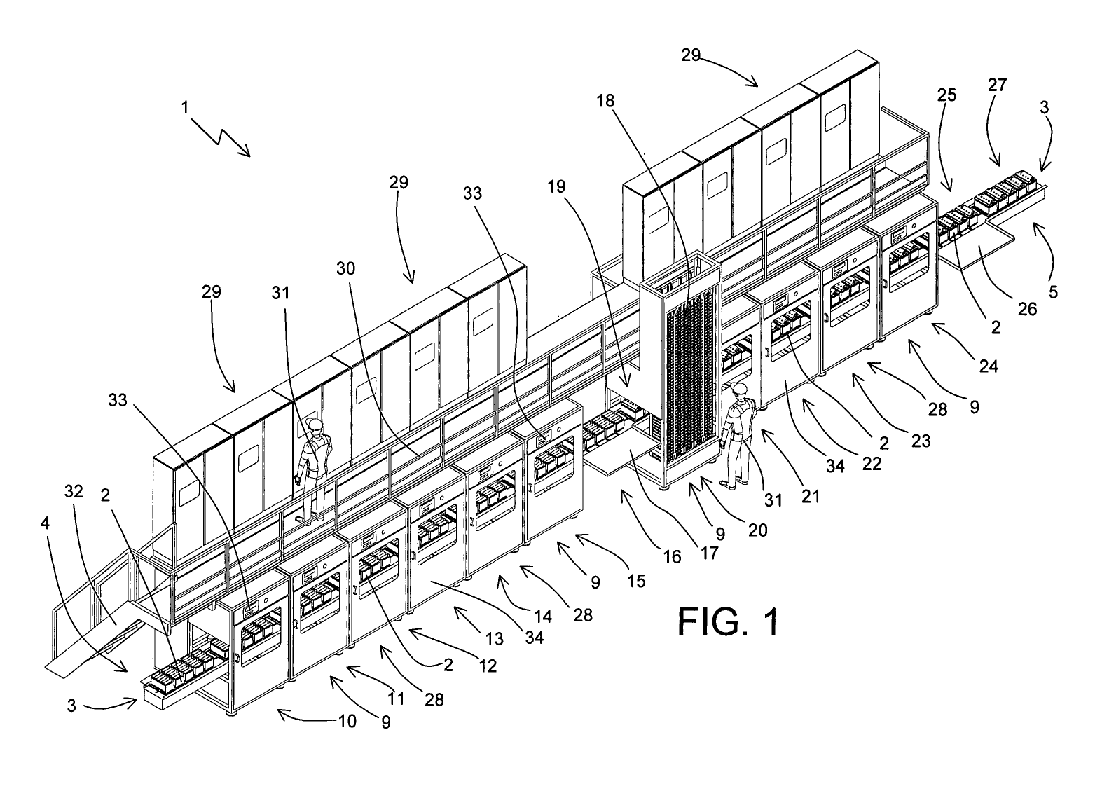

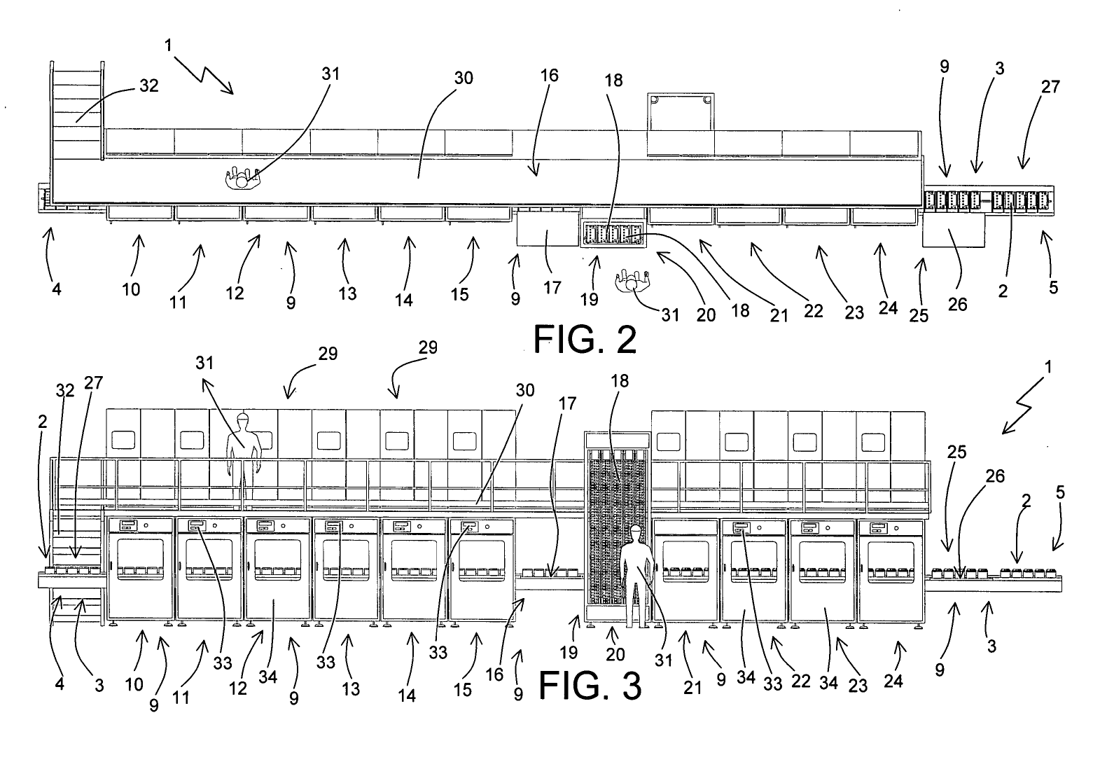

### DESCRIPTION OF THE PREFERRED EMBODIMENTS

With reference to the accompanying drawings, the numeral 1 denotes as a whole a line for assembling accumulator batteries 2 in accordance with the present invention.

The assembly line 1 according to the present invention comprises movement means 3 extending along a feed path between an infeed section 4, at which a battery 2 to be assembled is fed in, and an outfeed section 5 at which an assembled battery 2 is fed out.

Hereinafter, the term battery 2 to be assembled refers at least to a battery 2 container body 6 inside which the individual internal elements are mounted (accumulators not illustrated in the accompanying drawings).

However, depending on the embodiments, the term battery 2 to be assembled may also imply either only the container body 6 still to be filled, or batteries 2 in which one or more of the operations described below have already been performed.

Depending on requirements, the movement means 3 may take any form suitable for the purpose. For example, they may consist of a conveyor belt, a sliding surface on which they are moved by suitable pushers, etc.

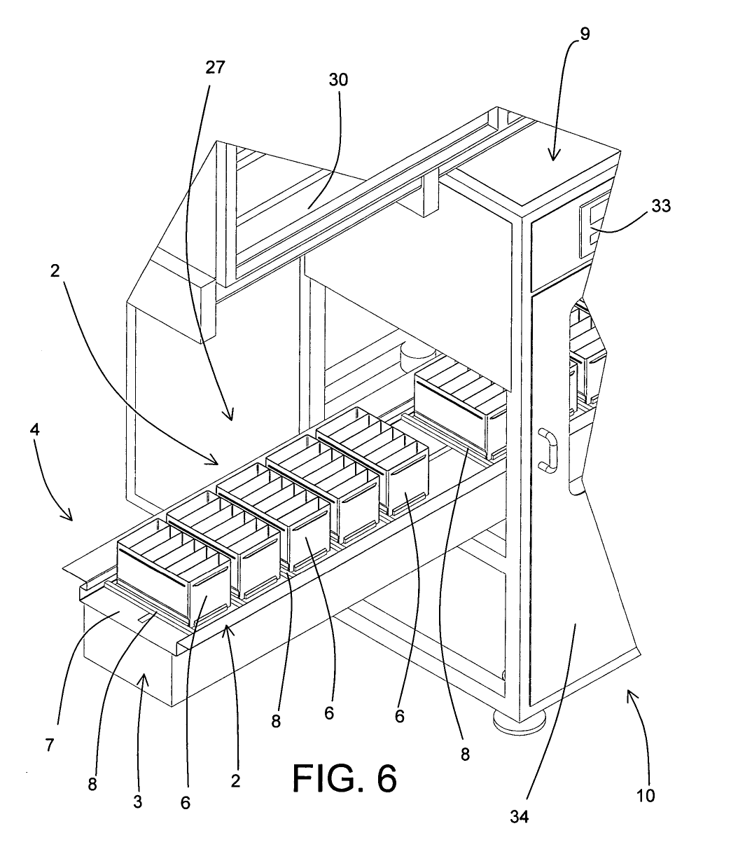

In the embodiment illustrated, in particular, the movement means 3 consist of a sliding surface 7 on which the batteries 2 are fed forward, pushed by suitable pusher bars 8 (FIG. 6).

Along the feed path for the batteries 2 there is a plurality of operating stations 9, each designed to perform at least one operation on the batteries 2.

In this way, the movement means 3, feeding the batteries 2 along the feed path, make them pass in sequence through each of the operating stations 9.

The accompanying drawings illustrate a complete assembly line 1, that is to say, equipped with a plurality of separate stations 9. In particular, the following may be identified in it, one after another from the infeed section 4 to the outfeed section 5:

a first test station 10 for testing against high voltage short-circuits, in which the resistance to short-circuits of the individual internal elements of the battery 2 is tested;

a first joining station 11 for the internal elements of the battery 2, in which the electrical connection is created, between the various internal elements of the battery 2, relative to the positive (negative) pole;

a second joining station 12 for the internal elements of the battery 2, in which the electrical connection is created, between the various internal elements of the battery 2, relative to the negative (positive) pole;

a second test station 13 for testing against high voltage short-circuits, in which resistance to short-circuits is tested after the various internal elements have been connected to one another;

a station 14 for performing continuity tests on the battery 2 internal electrical connections, to ensure that the joining guarantees electrical continuity between the various internal elements;

a station 15 for applying seals (hot cast rubber—hot melt);

a first reject station 16 for any batteries 2 found to be faulty during the tests carried out in the previous stations; this station will have suitable elements, not illustrated, designed to push the faulty batteries 2 sideways onto a first rejection surface 17;

a station 19 for applying lids 18 to the battery 2 container bodies, which in the accompanying drawings also has a lid 18 magazine 20;

a station 21 for joining the lids 18 to the battery 2 container body 6; this station may, for example have a heated plate (of the known type, therefore not illustrated) which is inserted between the battery 2 bodies and the relative lids 18 until they reach the softening temperature; then the plate is removed the lids 18 are pressed against the relative battery 2 body until the two fuse together;

a station 22 for joining the external terminals (not clearly visible) of the battery 2 to the internal terminals obtained by joining the individual internal elements;

a station 23 for testing the battery 2 pneumatic seal and/or the height of the battery 2 terminals;

a station 24 for stamping the battery 2 code;

and, finally, a second reject station 25 for any batteries 2 found to be faulty during the tests carried out in the previous stations; this station will also be equipped with suitable elements, not illustrated, designed to push the faulty batteries 2 sideways onto a second rejection surface 26.

Generally speaking, depending on requirements, each line 1 may have only some of the stations 9 listed above, arranged in the most appropriate sequence.

In accordance with the present invention, the movement means 3 are also set up to keep the batteries 2 being processed grouped in groups 27 each comprising a plurality of batteries 2 (five in the accompanying drawings).

In each group 27 the batteries 2 are kept near to one another along a respective main side, so as to limit the length of each group 27 in the direction parallel with the movement path (FIG. 6).

Moreover, the movement means 3 feed each group 27 of batteries 2, in a direction perpendicular to the main side of each battery 2, in sequence through the operating stations 9 present.

Advantageously, at least some of the operating stations 9 (preferably all of them) are able to carry out the relative operation simultaneously on all of the batteries 2 in a group 27.

Also, in the line 1 according to the present invention, each operating station 9 comprises an active zone 28 at which the operations are performed on the battery 2 and a control zone 29. The control zones 29 of the operating stations 9 are arranged above the relative active zones 28, to allow free access to the active zones 28 from both sides of the movement means 3.

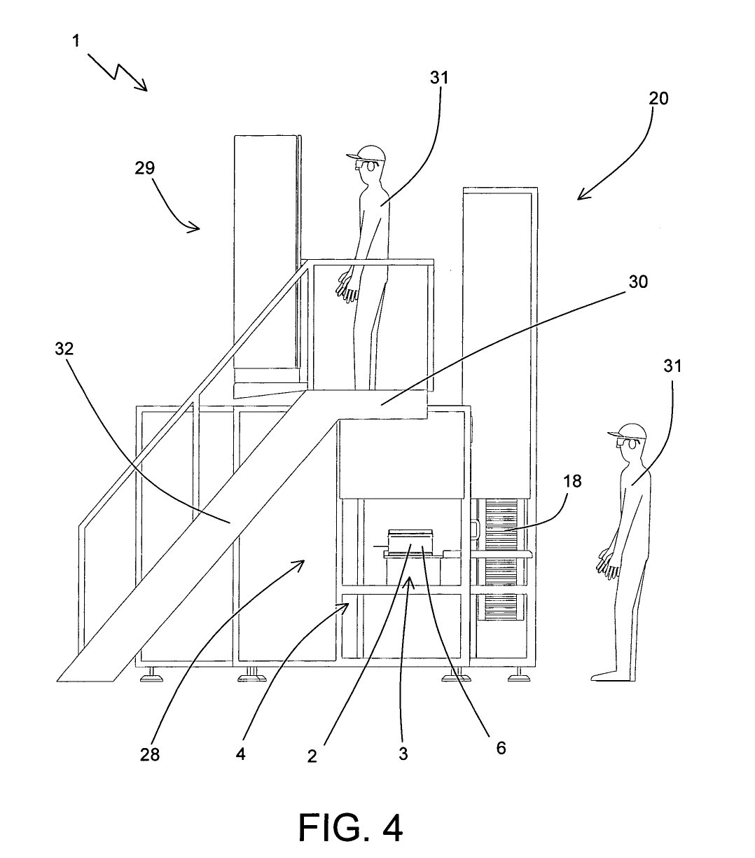

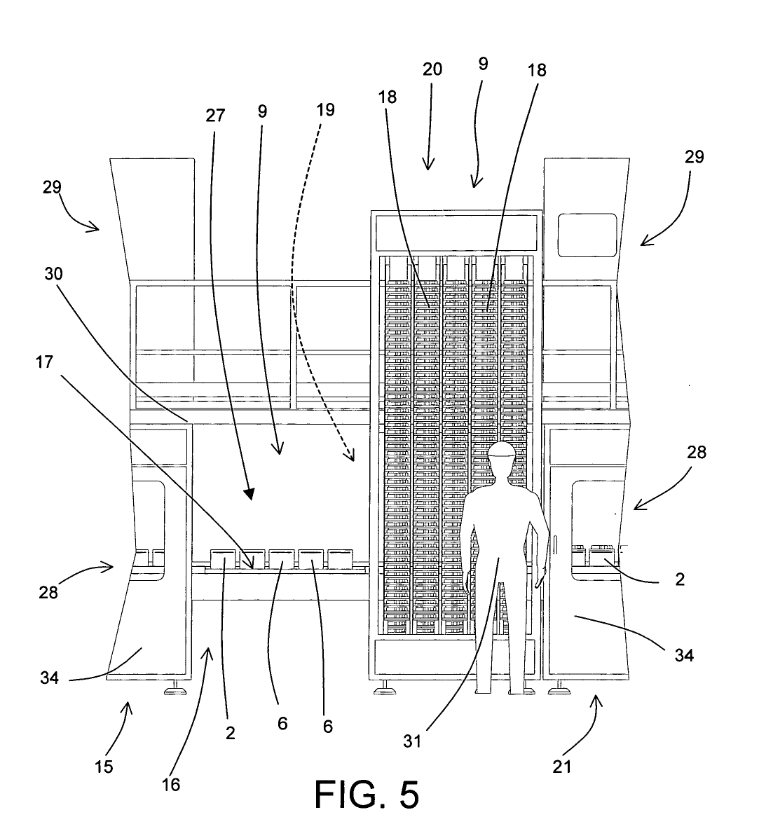

Moreover, the assembly line 1 comprises a suspended platform structure 30 positioned substantially above the movement means 3 (FIG. 4) which an operator 31 can access using at least one staircase 32 (or other means). The operating station 9 control zones 29 are located at the suspended platform structure 30, so that an operator 31 can access them standing on the suspended platform structure 30.

In any event, the main control and command instruments 33 of each operating station 9 are located at an upper part of the façade of the active zone 28 of the relative station (in the accompanying drawings, above the door 34 which gives access to the active zone 28 of each station 9).

As regards the assembly method disclosed, in general it comprises a first operating step in which at least one battery 2 to be assembled is picked up, and one or more subsequent operating steps in which the battery 2 is subjected to one or more actual assembly operations.

In particular, during the first operating step not just one battery 2 to be assembled is picked up, but rather a plurality (five in the accompanying drawings). Said batteries 2 are placed side by side along their main side to form a group 27 of batteries 2 to be assembled.

The subsequent operating steps are performed simultaneously on all of the batteries 2 in the group 27.

Preferably, the various steps are performed one after another in different operating zones along the same movement path for the group 27 of batteries 2. In particular, the group 27 of batteries 2 to be assembled is moved between the various operating zones, according to a direction of movement perpendicular to the main side of the batteries 2 of which it consists.

The operating steps which may be involved once the group 27 of batteries 2 has been created are the same as those performed by the operating stations 9 described above. Therefore, these steps may be:

a first step of testing against high voltage short-circuits;

a first step of joining battery 2 internal elements;

a second step of joining battery 2 internal elements;

a second step of testing against high voltage short-circuits;

a step of carrying out continuity tests on battery 2 internal electrical connections;

a step of applying seals;

a first rejection step for any faulty batteries 2;

a step of applying lids 18 to the battery 2 container bodies 6;

a step of joining the lids 18 to the container body 6;

a step of joining battery 2 external terminals;

a step of testing the battery 2 pneumatic seal and/or the height of the battery 2 terminals;

a step of stamping the battery 2 code;

and a second rejection step for any faulty batteries 2.

The present invention brings important advantages.

Firstly, the line and method for assembling accumulator batteries disclosed can guarantee a production capacity higher than the known lines and methods. Whilst in known systems each operating station performs its operations on a single battery, in the line disclosed each station simultaneously operates on a plurality of batteries. As a result, the other parameters being equal, the productivity which can be achieved with the present invention is equal to N times the productivity of conventional lines, where N is the number of batteries in each group.

The solution in which the batteries are drawn near one another along the main side allows limitation of the longitudinal dimension of the line, but still provides high levels of productivity. For example, consider that, in general, two batteries placed side by side on the main side have a total length along the other side which is slightly greater than the length of the main side. Consequently, with a slightly greater longitudinal extension productivity can be doubled compared with conventional lines. In another example, the line illustrated in the accompanying drawings is 18 m long and its productivity is rated as approximately 9 batteries/minute.

In addition, the assembly line disclosed has a smaller transversal dimension than that of known lines, thanks to its height.

Moreover, access to the battery feed path along the entire line is also facilitated.

It should also be noticed that the present invention is relatively easy to produce and even the cost linked to implementing the invention is not very high.

The invention described may be subject to modifications and variations without thereby departing from the scope of the inventive concept.

All of the details of the invention may be substituted by other, technically equivalent elements and in practice all of the materials used, as well as the shapes and dimensions of the various components, may be any according to requirements.

What is claimed:

1) A line for assembling accumulator batteries comprising:
movement means extending along a feed path between an infeed section for a battery to be assembled and an outfeed section for an assembled battery; and
a plurality of operating stations mounted along the feed path, each for performing at least one operation on the batteries;
the movement means being able to feed at least one battery along the feed path, in sequence through the operating stations;
wherein the movement means are prepared in such a way that they keep the batteries grouped in groups each comprising a plurality of batteries drawn near to one another along a respective main side, and wherein the movement means can be activated to move each group in sequence through the stations.

2) The assembly line according to claim 1, wherein the movement means feed each group of batteries according to a direction perpendicular with the main side of each battery.

3) The assembly line according to claim 2, wherein at least some of the stations can perform the relative operation simultaneously on all of the batteries in a group.

4) The assembly line according to claim 1, wherein at least some of the stations can perform the relative operation simultaneously on all of the batteries in a group.

5) The assembly line according to claim 1, wherein each operating station comprises an active zone at which the operations are performed on the battery and a control zone.

6) The assembly line according to claim 5, wherein the operating station control zones are above the relative active zone.

7) The assembly line according to claim 6, comprising a suspended platform structure positioned above the movement means and accessible to an operator, the operating station control zones being located at the suspended platform structure.

8) The assembly line according to claim 7, wherein each operating station is equipped with control and command instruments located at a portion of the lower active zone.

9) The assembly line according to claim 1, comprising one or more of the following operating stations: a first station for testing against high voltage short-circuits, a first station for joining battery internal elements, a second station for joining battery internal elements, a second station for testing against high voltage short-circuits, a station for performing continuity tests on battery internal electrical connections, a station for applying seals, a first reject station for any faulty batteries, a station for applying lids to the batteries which may have a lid magazine, a station for joining the lids to a battery container body, a station for joining battery terminals, a station for checking the battery pneumatic seal and/or the height of the battery terminals, a station for stamping a battery code and a second reject station for faulty batteries.

10) The assembly line according to claim 9, wherein the stations present are arranged along the feed path one after another in the order indicated.

11) The assembly line according to claim 5, comprising one or more of the following operating stations: a first station for testing against high voltage short-circuits, a first station for joining battery internal elements, a second station for joining battery internal elements, a second station for testing against high voltage short-circuits, a station for performing continuity tests on battery internal electrical connections, a station for applying seals, a first reject station for any faulty batteries, a station for applying lids to the batteries which may have a lid magazine, a station for joining the lids to a battery container body, a station for joining battery terminals, a station for checking the battery pneumatic seal and/or the height of the battery terminals, a station for stamping a battery code and a second reject station for faulty batteries.

12) The assembly line according to claim 11, wherein the stations present are arranged along the feed path one after another in the order indicated.

13) The assembly line according to claim 7, comprising one or more of the following operating stations: a first station for testing against high voltage short-circuits, a first station for joining battery internal elements, a second station for joining battery internal elements, a second station for testing against high voltage short-circuits, a station for performing continuity tests on battery internal electrical connections, a station for applying seals, a first reject station for any faulty batteries, a station for applying lids to the batteries which may have a lid magazine, a station for joining the lids to a battery container body, a station for joining battery terminals, a station for checking the battery pneumatic seal and/or the height of the battery terminals, a station for stamping a battery code and a second reject station for faulty batteries.

14) The assembly line according to claim 13, wherein the stations present are arranged along the feed path one after another in the order indicated.

15) A method for assembling accumulator batteries, comprising the following operating steps:
a first operating step in which a battery to be assembled is picked up; and
one or more successive steps in which the battery is subjected to one or more assembly operations;
wherein during said first operating step a plurality of batteries to be assembled is picked up, being placed side by side along the respective main side to form a group of batteries to be assembled, and wherein at least some of the successive operating steps are performed simultaneously on all of the batteries in the group.

16) The method for assembling batteries according to claim 15, wherein the group of batteries to be assembled is moved, in a direction of movement perpendicular to the main side of the batteries of which the group consists, through a plurality of operating zones in which the successive operating steps are performed.

17) The method for assembling batteries according to claim 16, comprising one or more of the following operating steps performed simultaneously on each battery in the group:
a first step of testing against high voltage short-circuits;
a first step of joining battery internal elements;
a second step of joining battery internal elements;
a second step of testing against high voltage short-circuits;
a step of performing continuity tests on battery internal electrical connections;
a step of applying seals;
a first step of rejecting any faulty batteries;
a step of applying lids to a battery container body;
a step of joining the lids to the container body;
a step of joining battery terminals;
a step of checking the pneumatic seal of the battery and/or the height of the battery terminals;
a step of stamping a battery code;
and a second step of rejecting faulty batteries.

18) The assembly line according to claim 17, wherein the steps involved are performed one after another in the order indicated.

19) The method for assembling batteries according to claim 15, comprising one or more of the following operating steps performed simultaneously on each battery in the group:
a first step of testing against high voltage short-circuits;
a first step of joining battery internal elements;
a second step of joining battery internal elements;
a second step of testing against high voltage short-circuits;
a step of performing continuity tests on battery internal electrical connections;
a step of applying seals;
a first step of rejecting any faulty batteries;
a step of applying lids to a battery container body;
a step of joining the lids to the container body;
a step of joining battery terminals;
a step of checking the pneumatic seal of the battery and/or the height of the battery terminals;
a step of stamping a battery code;
and a second step of rejecting faulty batteries.

20) The assembly line according to claim 19, wherein the steps involved are performed one after another in the order indicated.
